(19) United States
(12) Patent Application Publication
(10) Pub. No.: US 2002/0186229 A1
(43) Pub. Date: Dec. 12, 2002

(54) Rotatable display with sub-pixel rendering

(76) Inventor: Candice Hellen Brown Elliott, Vallejo, CA (US)

Correspondence Address: Finnegan, Henderson, Farabow,, Garrett & Dunner, L.L.P., 1300 I Street, N.W., Washington, DC, 20005-3315, US

(21) Appl. No.: 10/150,394

(22) Filed: May 17, 2002

Related U.S. Application Data
(63) Continuation-in-part of application No. 10/051,612, filed on Jan. 16, 2002.
(60) Provisional application No. 60/290,086, filed on May 9, 2001.
(60) Provisional application No. 60/290,087, filed on May 9, 2001.
(60) Provisional application No. 60/290,143, filed on May 9, 2001.
(60) Provisional application No. 60/313,054, filed on Aug. 16, 2001.

(51) Int. Cl. G09G 5/00

(52) U.S. Cl. 345/649

(57) ABSTRACT

In one embodiment, a system comprising a processor, an image storage and a display, said display capable of displaying an image, and said image being renderable in a plurality of rotation degrees upon said display upon a command is described. A method of rotating an image, said image further comprising at least one member of a group, said group comprising text and images capable of being sub-pixel rendered, comprises the steps: sub-pixel rendering said at least one member of a group with the inversion of a given rotation command; upon receipt of said rotation command, rotating said image. In yet another embodiment, a method of rotating an image, said image further comprising at least one member of a group, said group comprising text and images capable of being sub-pixel rendered, comprises the steps of: sub-pixel rendering said at least one member of a group; grouping said sub-pixels into a plurality of sub-pixel groups; rotating said plurality of sub-pixel groups such that each said sub-pixel group is rotated as a pixel on a pixel-to-pixel basis. In still yet another embodiment, a method of rotating an image, said image further comprising at least one member of a group, said group comprising text and images capable of being sub-pixel rendered, comprises the steps of: upon receipt of said rotation command, rotating said image in accordance with said rotation command; and sub-pixel rendering said at least one member of a group.

### RELATED APPLICATIONS

This application is a continuation-in-part and claims priority to U.S. patent application Ser. No. 10/051,612 (“the '612 application”), entitled “CONVERSION OF A SUB-PIXEL FORMAT DATA TO ANOTHER SUB-PIXEL DATA FORMAT,” filed on Jan. 16, 2002, which is hereby expressly incorporated herein by reference.

The '612 application claims priority to U.S. Provisional Patent Application No. 60/290,086, entitled “CONVERSION OF RGB PIXEL FORMAT DATA TO PENTILE MATRIX SUB-PIXEL DATA FORMAT,” filed on May 9, 2001; U.S. Provisional Patent Application No. 60/290,087, entitled “CALCULATING FILTER KERNEL VALUES FOR DIFFERENT SCALED MODES,” filed on May 9, 2001; U.S. Provisional Patent Application No. 60/290,143, entitled “SCALING SUB-PIXEL RENDERING ON PENTILE MATRIX,” filed on May 9, 2001; and U.S. Provisional Patent Application No. 60/313,054, entitled “RGB STRIPE SUB-PIXEL RENDERING DETECTION,” filed on Aug. 16, 2001, which are all hereby expressly incorporated herein by reference.

### FIELD OF INVENTION

The invention pertains to the field of computer displays. More specifically, this invention pertains to rotation of color sub-pixelated displays using sub-pixel rendering.

### BACKGROUND

Computer displays typically are constructed in a manner to display text and other video information in a landscape mode. There have been, of course, some displays that are constructed to display video data in portrait mode. To bridge the gap between the two modes of displays, some have built software drivers to enable a display to be rotated between landscape and portrait mode (i.e. typically 90, 180, or 270 degrees) and then to hit a software switch (either automatically or under user-controlled input) in order to render the image “right-side up”. Badger, in U.S. Pat. No. 5,973,664, describes such a prior software system that enables the mapping of pixel information from one mode to the other—and hence, enables a rotatable display for desired user control.

Badger describes his system succinctly in FIGS. 1, 2 and 3. FIG. 1 illustrates the modification of an image before it is sent to a rotated computer display. Computer display 100a is oriented in standard landscape mode, displaying an image which is taller than it is wide. The space on either side of the image is wasted. The user of rotatable display 100a can rotate it 90 degrees clockwise, which would result in computer display 100b. The image on display 100b appears rotated 90 degrees, however, because of the rotation of the display. In order to view the image upright as on rotated display 100c, the computer compensates for the clockwise rotation of the display by sending to the display an image which is rotated 90 degrees in the counterclockwise direction. The image sent by the computer to display 100c would look like that on display 100d if the display were left in the standard landscape orientation.

An illustrative embodiment of Badger's system is shown in FIG. 2. Computer display 216 exhibits image 218 based on display image information 210 stored in display memory 212, which is accessible by computer 220. This display memory 212 is organized into arrays of memory cells, and the organization of information in display memory 212 takes the form of contiguous blocks of memory which each represent a single horizontal line of pixels on the display. Video hardware 214 uses display image information 210 in display memory 212 to generate display signals for computer display 216. The appearance of image 218 on computer display 216 is determined by the organization of information 210 placed in display memory 212. When software application 200, such as a word processor or a drawing program, needs to put an image 204 on display screen 216, it typically places image information 204 in source memory 202. Application 200 then signals operating system 206 that image 204 in source memory 202 needs to be put on display screen 216. Operating system 206 then communicates this information to driver 208. Driver 208 is a small software program which performs the task of retrieving source image information 204 from source memory 202 and putting it into display memory 212. If any modifications to the orientation of image 204 are necessary, driver 208 performs these modifications while writing display image information 210 to display memory 212. Driver 208 performs all modifications to image 204 using a single parameterized method of operation that can be used to rotate image 204 for any of a number of orientation modes.

Referring now to FIG. 3, image 210 to be shown on computer display 216 is in the form of an array of display image lines 306, with each display image line 306 being an array of pixels 308. Driver 208 transfers image 204 line by line, pixel by pixel from source memory 202 to display memory 212. Computer display 216 shows what is in display memory 212, and driver 208 can change the orientation of displayed image 218 by changing the ordering of pixels 308 of image 210 in display memory 212. In FIG. 3, an image of an arrow is shown in source memory 202. Display memory 212 contains an image of the same arrow rotated counterclockwise 90 degrees. The mapping of pixels 304 from source memory 202 to display memory 212 is illustrated by the three pixels marked A, B, and C, which are mapped to the three pixels 308 marked A′, B′, and C′.

When a user wishes to change the orientation of images 218 on computer display 216, the user makes a selection of one of a variety of possible orientation modes. When this selection occurs, driver 208 is notified, and a setup procedure begins so that images 218 later drawn to computer display 216 will have the desired orientation. This setup procedure involves using information about the desired orientation to calculate two increment parameters, X.sub.—Increment and Y.sub.—Increment. The X.sub.—Increment parameter indicates the difference in display memory 212 between pixels 308 which correspond to adjacent pixels 304 of the same source image line 302 in source memory 202. For example, pixels A and B are adjacent pixels 304 of the same source image line 302 in FIG. 3. For display image 210, the values of these two pixels 304 are transferred to A′ and B′ in display memory 212. The difference in memory addresses between A′ and B′ in display memory 212 is the X.sub.—Increment parameter. The Y.sub.—Increment parameter is the difference in display memory 212 between pixels 308 which correspond to adjacent pixels 304 of different source image lines 302 in source memory 202. For display image 210, pixels A′ and C′ correspond to pixels A and C of source memory 202, A and C being adjacent pixels 304 of different source image lines 302 in source memory 202. The difference in memory addresses between A′ and C′ in display memory 212 is the Y.sub.—Increment parameter.

When driver 208 is notified that image 204 is to be displayed on computer display 216, driver 208 invokes a set of software instructions to transfer image information 204 from source memory 202 into display memory 212 using the X.sub.—Increment and Y.sub.—Increment parameters, which are modified depending on the desired orientation mode. As each pixel 304 in a source image line 302 is transferred from source memory 202 to display memory 212, driver 208 determines the new pixel 308 location in display memory 212 by adding the X.sub.—Increment parameter to the location of the previous pixel 308 from that source image line 302. Each time a new source image line 302 is begun, the Y.sub.—Increment parameter is added to the location in display memory 212 of the first pixel 308 of the previous source image line 302. After the location in display memory 212 of the first pixel is determined, the location in display memory 212 of each subsequent pixel can be determined from the two increment parameters. In this way, the same set of instructions can effect the transfer of image information 204 regardless of which orientation mode selected, merely by changing the values of the X.sub.—Increment and Y.sub.—Increment parameters according to the selected orientation mode.

As useful as the Badger's system is (as depicted in FIGS. 1, 2 and 3) and while it is clearly desirable to have such user-flexibility in a display, the main limitation to the system disclosed by Badger is that the mapping takes places at the pixel-level—and no finer level of mapping is described. Today's displays are taking advantage of sub-pixel rendering—methods and apparatus that allow for a finer resolution of video data (in particular, text). In fact, both Microsoft and Adobe have methods that allow for sub-pixel rendering using the traditional RGB stripe.

Part of the problem is that prior art displays (particularly those relying on the RGB stripe) suffer from a non-rotationally symmetrical Nyquist limit, addressability, and/or MTF response curve. When images are rotated on a display that is non-symmetrical, the direction that has the least performance limits the image quality as the image component requiring greater performance passes through that angle.

For example, many, if not most, western text (Latin & Cyrillic) have more high spatial frequency components in the horizontal than the vertical direction. These high spatial frequencies are spread over a range of frequencies and phases. On a display with fixed square pixels, only certain high spatial frequencies and phases can be displayed. On a prior art RGB Stripe panel, display sub-pixel rendering offers higher addressability, thus allowing higher spatial frequencies to have a greater range of phases, but only in the direction normal to the stripes. Thus fonts are best rendered using sub-pixel rendering with the stripes aligned vertically, in line with the majority of long strokes of most of the characters. Displays conventionally meet this requirement when the lines of text are aligned horizontally along the long axis of typical flat panel displays in the so called “landscape” orientation. But when the lines of text are aligned with the short axis, and the display physically rotated to the so called “portrait” orientation, desired to allow display of full pages of text, as they are usually printed on paper in the “portrait” orientation, the stripes are normal to the long strokes. Since sub-pixel rendering only increases the addressability normal to the stripes, the conventionally oriented striped panel is suboptimal for use in sub-pixel rendering text in the portrait orientation, as the text requires greater addressability in the ‘wrong’ axis.

For this reason, the stripes should be aligned vertically in portrait mode. This requires that the display be designated for use as a portrait display only. But many displays would benefit from the ability to be used in both modes. Many advantageous uses would abound—e.g. a flat panel monitor on a support that allows the user to rotate the display between portrait orientation for word processing and landscape orientation for other work; a so-called “tablet computer” or “Personal Digital Assistant” (“PDA”) that allows the user to read an electronically stored book in portrait orientation and turn it to view it in landscape orientation to view a calendar. Thus, it is highly desirable to have a display that allows equal sub-pixel rendering performance in both portrait and landscape orientations.

For some uses of flat panels, images are rotated at any or even all angles. One such use is for navigation aids in automobiles and handheld devices such as Geo Positioning System (GPS) enabled map displays. As the car or user changes orientation with respect to the terrain, the map rotates in the counter direction on the display to keep the relative orientation of the displayed map image aligned with the terrain. On prior art displays, such as the RGB Stripe display, conventional whole pixel rendering allows higher spatial frequencies in the diagonal directions. Images that are rotated on the display change quality depending on whether the high spatial frequencies are in alignment with the diagonals or not. Thus, an image, such as a map, seems to shift in appearance (and, potentially, usability) as the image is rotated. Thus, it is highly desirable to have a display that has equal performance in any and all orientations. That is to say, its Nyquist Limit, addressability, and/or MTF response curves are equal in all directions. If these response functions were plotted for such a display, they would from a circle with the center at zero spatial frequency—as will be discussed in greater detail below.

The family of display architectures—disclosed in the commonly owned U.S. patent application Ser. No. 09/916,232 with Publication No. 2002/0015110 A1 to Candice Hellen Brown Elliott, entitled “ARRANGEMENT OF COLOR PIXELS FOR FULL COLOR IMAGING DEVICES WITH SIMPLIFIED ADDRESSING,” and known under the trademark name PENTILE™—all share the common trait of a red and green sub-pixel checkerboard upon which luminance information is mapped using sub-pixel rendering. When these displays sub-pixel render images that are rotated about, the image quality and appearance remains substantially constant due to the symmetrical nature of the red and green sub-pixel checkerboard layout and the filter response of the sub-pixel rendering algorithms. If the Nyquist Limit, addressability, and/or MTF response curves are plotted for these display architectures, it is found that they are circles with the center at zero spatial frequency.

Since a display with a circular response has equal performance in all direction, it follows that it must also have equal performance in landscape and portrait orientations.

In addition to the problems mentioned above regarding the quality of text when sub-pixel rendered on said RGB Stripe displays, another problem occurs when the prior art RGB stripe sub-pixel rendering methods are followed by a pixel-to-pixel rotational mapping, such as e.g. taught by Badger. Typically, as is often attempted in commercial use, the sub-pixel rendering of text is performed by the operating system, and the screen image rotation and/or mirror performed by a ‘driver’ afterwards. The problem arises when the text rendering code assumes that the sub-pixel stripes are aligned normal to the line of text (aligned with the tall stems of Western fonts). The sub-pixel rendered data is then remapped, improperly, by the screen rotation method such as taught by Badger, which has as an internal assumption, that the data is conventional, non-sub-pixel rendered data. That is to say that each red, green, and blue data point per pixel represent a color sample that is coincident. In sub-pixel rendered data, this assumption is false. When rotated by the Badger method, the sub-pixel rendering is “scrambled”.

### SUMMARY

One present embodiment is a method to modify the prior art RGB stripe sub-pixel rendering methods such that the assumption is that the screen to be used in portrait orientation, with the stripes running horizontally in this orientation, obtaining feedback from the parameters taught in Badger. This will allow the text rendering code to use a set of displaced filters that match the conditions of the parameters.

One present embodiment pre-sub-pixel renders the desired text, one character at time, that is to be rotated and/or mirrored to the orientation indicated by the selected parameters by a pixel to pixel rotational mapping scheme. Then each character bit map may be rotated by the pixel to pixel rotational mapping, such as taught by Badger, or any other suitable method, but in the converse (inverse) manner, before being stored as a bit map. If such a character were plotted to the graphics memory plane to its selected position, it would appear to be scrambled. When the entire image is rotated by the Badger, or other suitable method, the sub-pixel rendering is “unscrambled” back to its intended, useful alignment.

Another embodiment is to write sub-pixel rendered data for text, as well as all graphics, at the desired rotational orientation.

Yet another embodiment is to perform the rotation of conventional, high resolution images before sub-pixel rendering. Conventional data is drawn to the graphic memory plane. Using the Badger, or other suitable methods, the image is rotated and/or mirrored. Then the data is filtered and sub-pixel rendered. The display to which the data is sub-pixel rendered and displayed onto may be an RGB stripe, delta triad, Bayer, PENTILE™, or any other suitable sub-pixelated type display. If the display is a PENTILE™ display (as depicted in U.S. patent application Ser. No. 09/916,232 with Publication No. 2002/0015110), the sub-pixel rendering may be the method described in the related '612 patent application as herein incorporated by reference.

In yet another embodiment, a system comprising a processor, an image storage and a display, said display capable of displaying an image, and said image being renderable in a plurality of rotation degrees upon said display upon a command is described. A method of rotating an image, said image further comprising at least one member of a group, said group comprising text and images capable of being sub-pixel rendered, comprises the steps: sub-pixel rendering said at least one member of a group with the inversion of a given rotation command; upon receipt of said rotation command, rotating said image.

In yet another embodiment, a method of rotating an image, said image further comprising at least one member of a group, said group comprising text and images capable of being sub-pixel rendered, comprises the steps of: sub-pixel rendering said at least one member of a group; grouping said sub-pixels into a plurality of sub-pixel groups; rotating said plurality of sub-pixel groups such that each said sub-pixel group is rotated as a pixel on a pixel-to-pixel basis.

In still yet another embodiment, a method of rotating an image, said image further comprising at least one member of a group, said group comprising text and images capable of being sub-pixel rendered, comprises the steps of: upon receipt of said rotation command, rotating said image in accordance with said rotation command; and sub-pixel rendering said at least one member of a group.

Other features and advantages of the present invention will be apparent from the following detailed description.

### BRIEF DESCRIPTION OF THE DRAWINGS

The accompanying drawings, which are incorporated in and constitute a part of this specification, illustrate exemplary embodiments of the invention and, together with the description, serve to explain the principles of the invention. In the figures,

FIG. 1 depicts various display and image orientations that are enabled with a prior art pixel to pixel rotational mapping scheme;

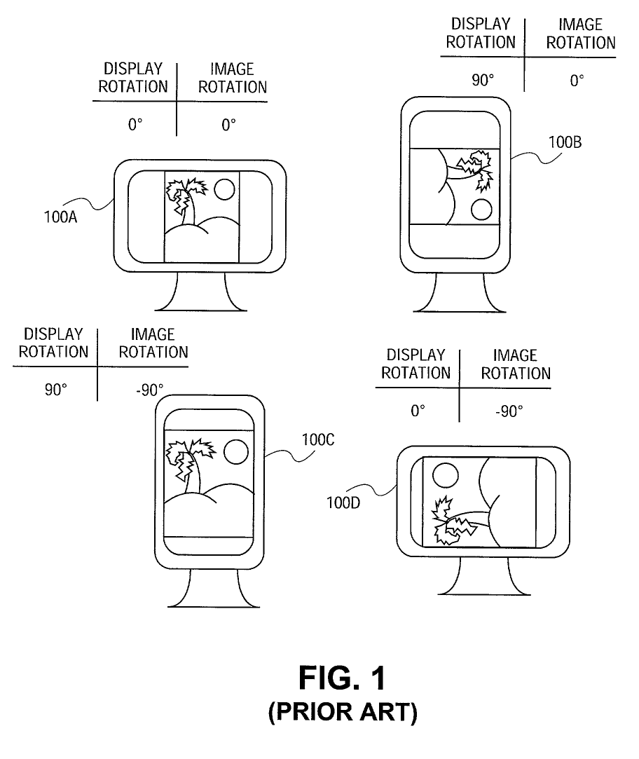

FIG. 2 shows an embodiment of a prior art computer system that implements a pixel to pixel rotational mapping scheme as taught by Badger;

FIG. 3 illustrates the relation of source memory to display memory in the system taught by Badger;

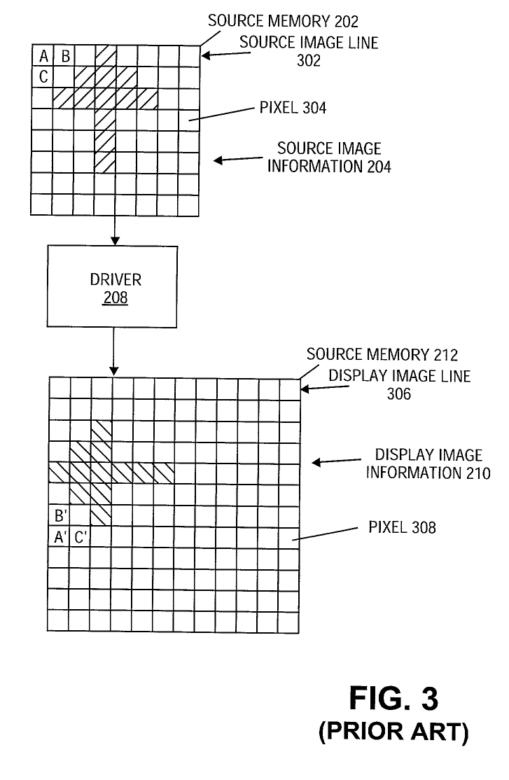

FIG. 4 is an illustration of prior art sub-pixel rendering of a text character on an RGB stripe display;

FIG. 5 is an illustration of the results of rotating the image of FIG. 4 using a prior art method;

FIG. 6 is an illustration of the desired results of rotating the image of FIG. 4 using the present invention;

FIG. 7 is one embodiment of a method as practiced in accordance with the present invention;

FIG. 8 is an illustration of a manner of storing and rendering the image of FIG. 6 prior to rotating the image according to the present invention;

FIG. 9 is diagram comparing the Nyquist and addressability limits of RGB stripe and PENTILE™ displays to the relative addressability requirements of western type fonts;

FIG. 10 is an illustration of sub-pixel rendering of a text character on a PENTILE™ 1 display;

FIG. 11 is an illustration of the results of rotating the image of FIG. 10 using the present invention;

FIG. 12A is another embodiment of the methods as practiced in accordance with the present invention;

FIG. 12B is an illustration of sub-pixel rendering of a text character on PENTILE™ 2 display;

FIG. 13 is an illustration of sub-pixel rendering of a text character on a PENTILE™ 1 display;

FIG. 14 is an illustration of the results of rotating the image of FIG. 9 using the present invention; and

FIG. 15 is yet another embodiment of a method as practiced in accordance with the present invention.

### DETAILED DESCRIPTION

Reference will now be made in detail to implementations and embodiments of the present invention as illustrated in the accompanying drawings. Wherever possible, the same reference numbers will be used throughout the drawings and the following description to refer to the same or like parts.

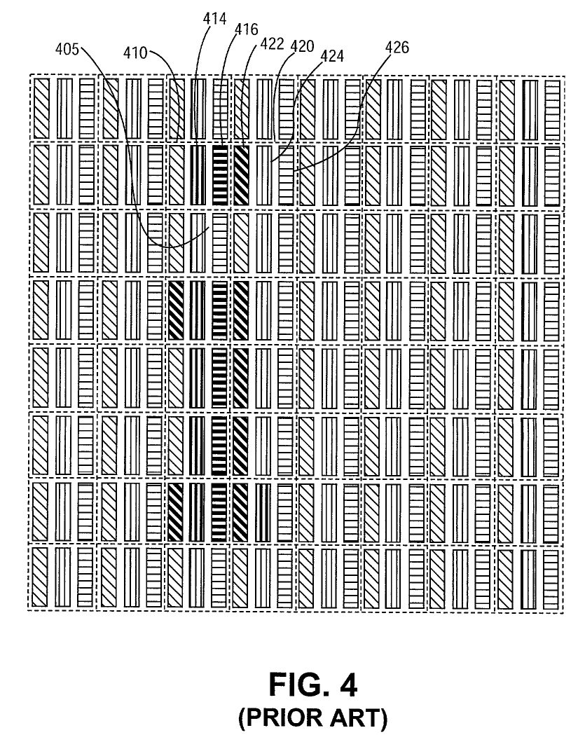

FIG. 4 shows an exemplary text character—“i”, in this case—sub-pixel rendered by a suitable prior art method for an RGB Stripe. As shown, this represents black text on a white background. It should be noted that the sub-pixels attempt to shape, or reconstruct, an idealized character—it is an approximation due to the limitations of the number of sub-pixels available. It should also be noted that the ‘dot’ 405 of the “i” overlaps the traditional boundaries of the conventional non-sub-pixel rendered fixed pixel definition—as shown by the dashed line boundaries 410 and 420. The red sub-pixel 422 and the green 414 and blue 416 sub-pixels form a new “logical pixel” that is shifted and lying across the two original pixels 410 and 420. Thus, the original, conventional pixel 410 when stored, would appear to be red—as only the red sub-pixel 412 is turned on. The conventional pixel 420, when stored, would be appear to be cyan—as only the green 424 and blue 426 sub-pixels are turned on.

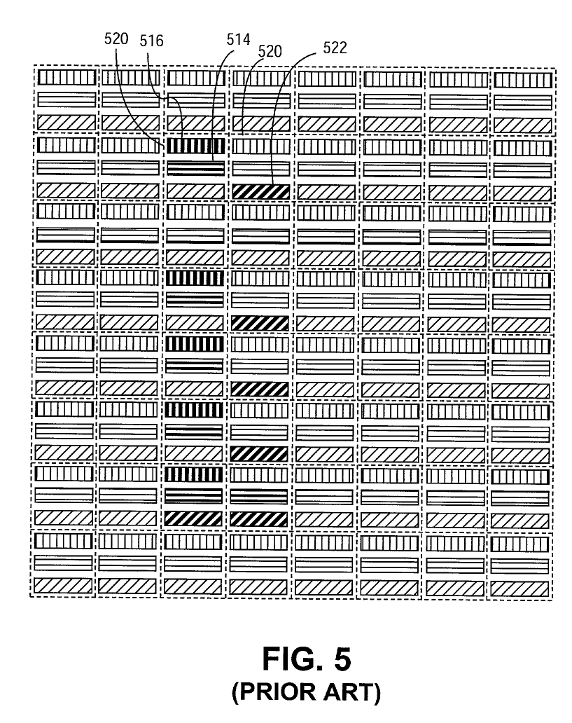

When the display of FIG. 4 is rotated counter clockwise and the image of the text is rotated clockwise to keep the character upright (as in a manner taught by the Badger or some other similar method), the same two values, red and cyan are applied to corresponding conventional pixels 510 and 520—as shown in FIG. 5 respectively. However, as the sub-pixel stripes are turned counter clockwise, the sub-pixels that formerly made up the ‘dot’ no longer line up to make a logical pixel. Thus, this method of rotating the image fails to maintain sub-pixel rendering utility.

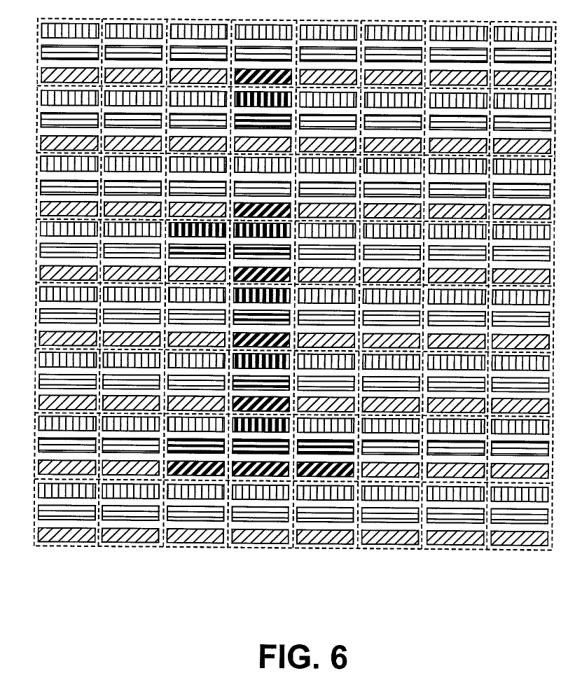

Referring now to FIG. 6, the text “i” character is shown when it is sub-pixel rendered correctly on a counter clockwise rotated display. It should be noted that the sub-pixels attempt to reconstruct an idealized character is only an approximation due to the limitations of the number of sub-pixels available. It should also be noted that its appearance is significantly different than that of FIG. 4, due to the sub-pixel architecture and its resulting Nyquist Limit, MTF, and addressability. FIG. 6 shows the desired image after rotation.

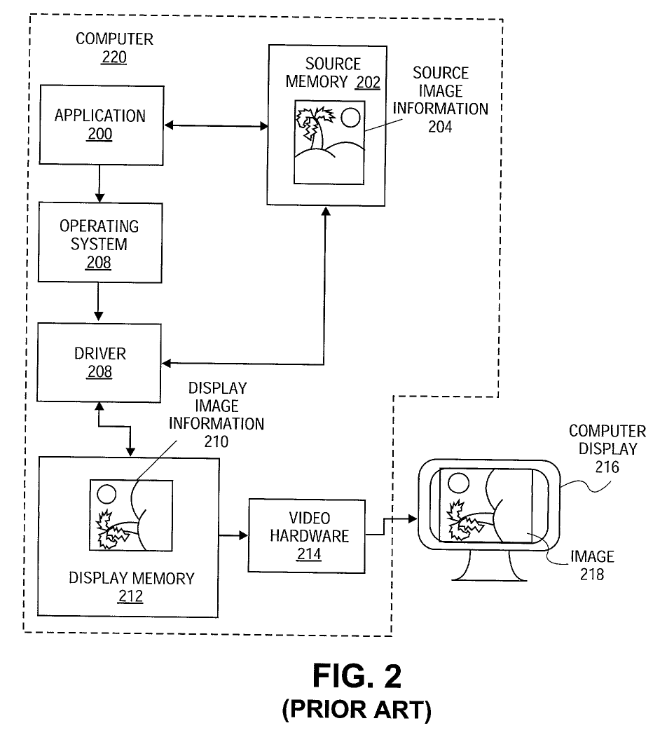

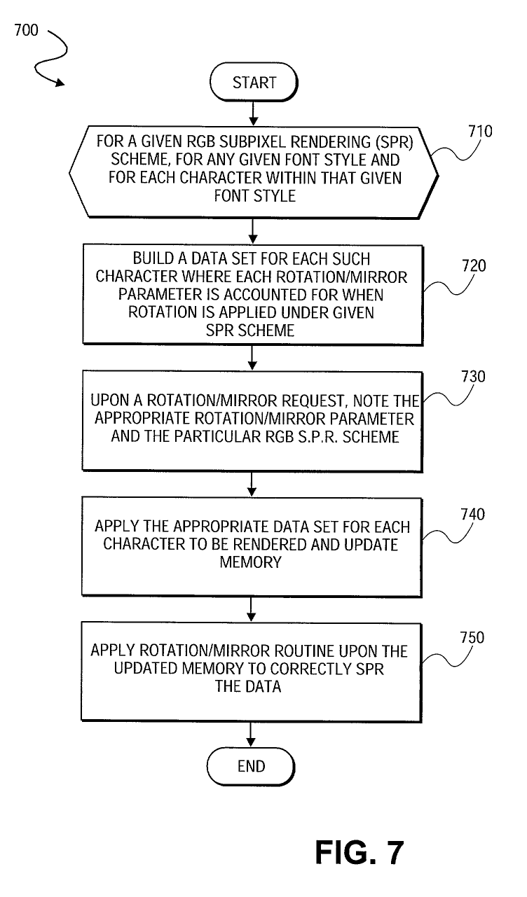

One embodiment for achieving this according to the present invention is presented in FIG. 7. Method 700 starts at step 710, by noting a number of different RGB sub-pixel rendering (SPR) schemes, font styles and the characters within such font style needs to be dealt with appropriately. A data set is built at step 720 for each such character for a given font style and a given SPR scheme whereby the data set takes into account the various rotation/mirror parameters to be requested. It will be appreciated that such a data set could be pre-processed and stored in memory somewhere with a computer system, such as shown in FIG. 2. Alternatively, the data set in question could be built in real time a rotation/mirror request is made based upon the system knowledge of the font style and given RGB SPR scheme being applied.

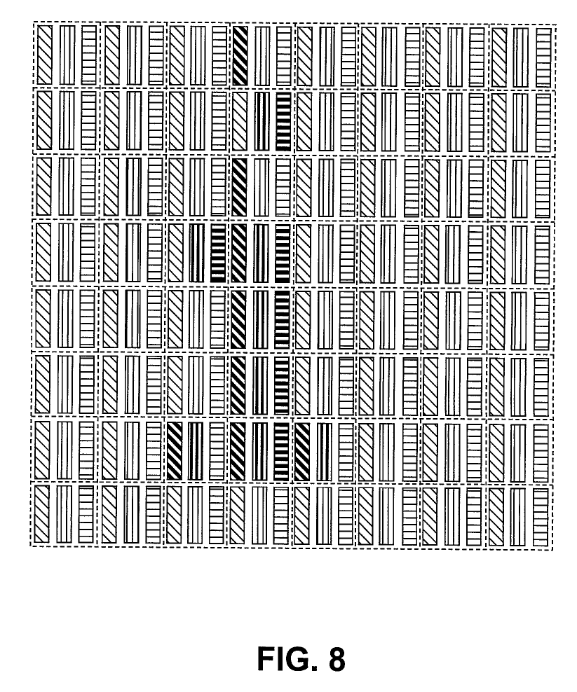

FIG. 8 is a pictorial example of just such a data set for the character “i” when the particular RGB stripe of FIG. 8 is given an instruction to rotate screen counter-clockwise and the data to be viewed in “right-side” up in portrait mode. Referring back to FIG. 7, at step 730, upon a rotation/mirror request, the system has knowledge of the appropriate rotation/mirror parameters and the particular RGB SPR scheme. Of course, this system knowledge could reside in and be accessed by many different parts of the system. For example, the knowledge could be resident in the application that is having the data rendered in the first instance. Alternatively, it could reside in the operating system or even the driver parts of the system. It should be noted that method 700 can have any number of variations to achieve the same result.

At step 740, the appropriate data set is applied on a character-by-character basis and the memory for the image is updated accordingly. It should be appreciated that data sets could be applied on other than a character-by character basis. In fact, groups of characters could constitute a separate data set and, for non-text images, similar grouping of data sets according to image information could be similarly constructed and applied. Additionally, the memory of the image to be rotated/mirrored could reside in various parts of the computer system.

At step 750, the requested rotation/mirror command is applied to the updated memory image—which correctly renders the image according the rotation/mirror command and the particular SPR scheme present. It will be appreciated that the steps of the present embodiment are not necessarily to be presented in the order described and that the present invention contemplates all obvious variations of the above embodiment.

Another embodiment of this method is to note the rotation and/or mirror parameters of the rotation method (e.g., by Badger, or some other similar method) to know what orientation the display sub-pixels will be. Then, a suitable method of sub-pixel rendering is applied, such as various displaced filter methods taught in the prior art or in the '612 application to pre-sub-pixel-render each character in the type font set. The image may then be rotated with the converse (inverse or reverse) operation to that to be later performed by the Badger method, or some other similar and suitable method, then the result may be stored as bit maps or as another memory scheme. The result of this converse (inverse or reverse) operation on the image then produces the desired result. When called upon by an application, such as a word processor, the image could then be plotted to the desired location in the graphic memory plane, where it is remapped/rotated by the Badger, or other similar method.

Reviewing the appearance difference of the sub-pixel rendered character “i” in FIGS. 4 and 6, the reason it exits is that the RGB stripe display architecture is asymmetric, giving rise to an asymmetric addressability. The addressability is greater in a direction normal to the orientation of the stripes.

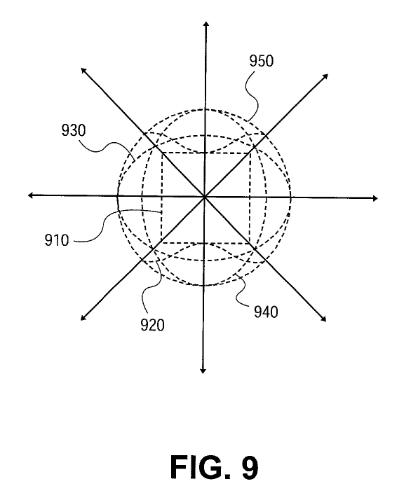

FIG. 9 compares the Nyquist limit and the addressability of RGB stripe and PENTILE™ displays to each other and to the addressability requirements of typical western font type (Latin and Cyrillic). The origin, the intersection of the four axial lines, represents zero spatial frequency. The graph space around it represents spatial frequencies to be displayed on the panel in the orientation as depicted. Thus, horizontal spatial frequencies are represented along the horizontal axis line, vertical spatial frequencies along the vertical axis line, and so on. The convention followed here is that the RGB stripe display response is plotted for stripes in the vertical orientation, while the PENTILE™ display's blue stripes are similarly oriented.

In FIG. 9, the Nyquist limit 910 of the RGB stripe display is shown in dashed lines. It should be noted that it forms a square in the spatial frequency space—and that it has equal limits in the horizontal and vertical axis; but has a higher limit for diagonal spatial frequencies. Without sub-pixel rendering, the Nyquist limit 910 and addressability limit 910 are the same. The Nyquist limit 910 is the same for both non-sub-pixel rendered and sub-pixel rendered images.

The sub-pixel rendering addressability limit 920 of the RGB stripe is shown. It should be noted that it has twice the addressability (since only the red and green sub-pixels substantially participate in addressability improvement using sub-pixel rendering in the horizontal than in the vertical axis. When western text lines are horizontally orientated (that is, running normal to the stripes), its relative addressability requirement 930 is plotted. This curve forms an ellipse. In this orientation, the relative addressability requirement 930 is aligned optimally with the RGB stripe addressability limit 920. The increase in addressability with sub-pixel rendering is responsible for the increase in perceived text quality over non-sub-pixel rendering.

The relative addressability requirement of western text that is vertically oriented (that is, running in-line with the stripes) plotted in 940. In this orientation, the relative addressability requirement 940 is aligned in the least optimal orientation with the RGB stripe addressability limit 920. There is still some increase in perceived text quality due to sub-pixel rendering over non-sub-pixel rendering, so the use of sub-pixel rendering is still warranted.

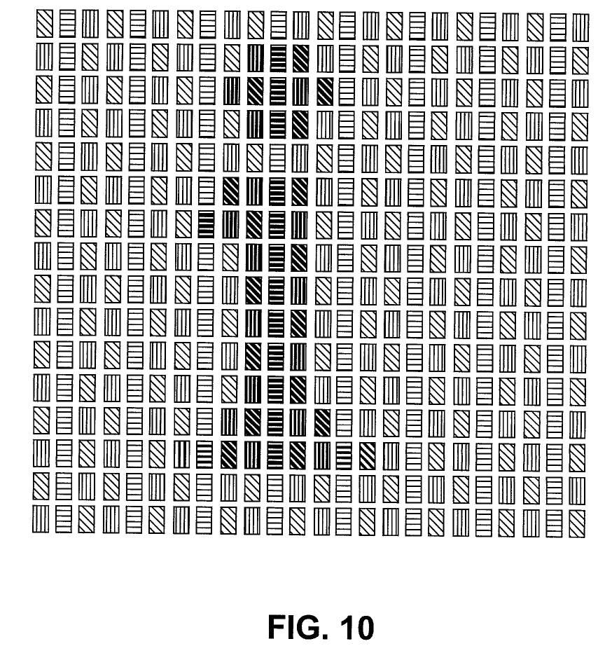

The sub-pixel rendering Nyquist limit 950 and sub-pixel rendering addressability limit 950 are the same for some PENTILE™ architectures shown in FIGS. 10, 11 and 12B. It is to be noted that it is symmetrical and coincident, due to the nature of the substantially symmetrical layout of the red and green sub-pixels—forming substantially a checkerboard pattern. When compared to the horizontally aligned text relative addressability requirement 930 and vertically aligned text relative addressability requirement 940, note that the rotation orientation of the PENTILE™ sub-pixel rendering Nyquist limit 550 and sub-pixel rendering addressability limit 550 allow for substantially equal image quality in any axis.

Thus, the PENTILE™ sub-pixel architecture is better suited for rotated text or graphics images, at any angle of rotation.

A method of using and rotating images for sub-pixelated panels comprises rotating a high resolution conventional, non-sub-pixel rendered image, using the Badger, or other suitable method, followed by sub-pixel rendering as described in the '612 application, or any other suitable method. By sub-pixel rendering after the rotation, the sub-pixel rendering need not suffer disruption as noted earlier. It will be appreciated that such a suitable sub-pixel rendering algorithm could reside and/or operate in either the graphics system in a computer, before it is transferred to the display by methods, such as analog or digital signal on cable—as is generally known in the art. Alternatively, the rotated high resolution image may be sent to a standalone monitor, in which a display controller may perform the sub-pixel rendering, perhaps in conjunction with scaling methods such as found in the '612 application or other suitable methods.

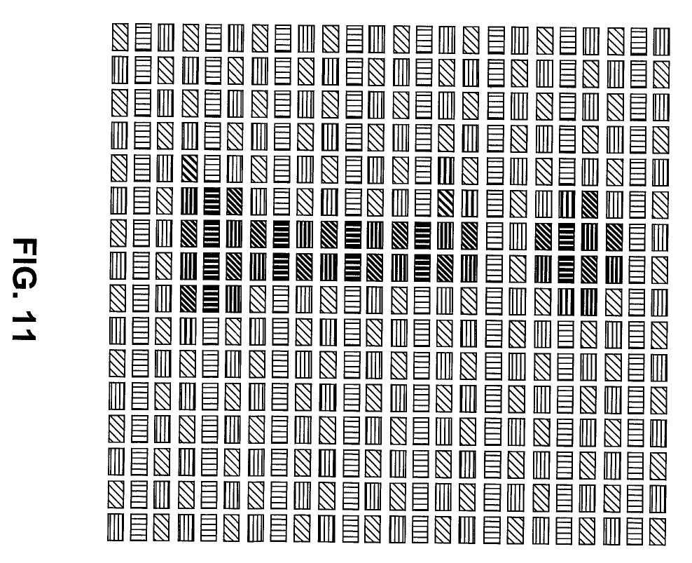

FIGS. 10 and 11 show the text character “i”, sub-pixel rendered, by any suitable method. As shown, this character represents black text on a white background. It will be noted that the sub-pixels attempt to shape, or reconstruct, an idealized character; but—as described before—due to the limitations of the number of sub-pixels available, it is only an approximation. However, it is readily seen that it is a better approximation than using sub-pixel rendering on the RGB stripe panel. FIG. 11 shows the results of rotating the panel one direction, while rotating the image in the counter direction, before sub-pixel rendering. It should be noted how similar the two images are.

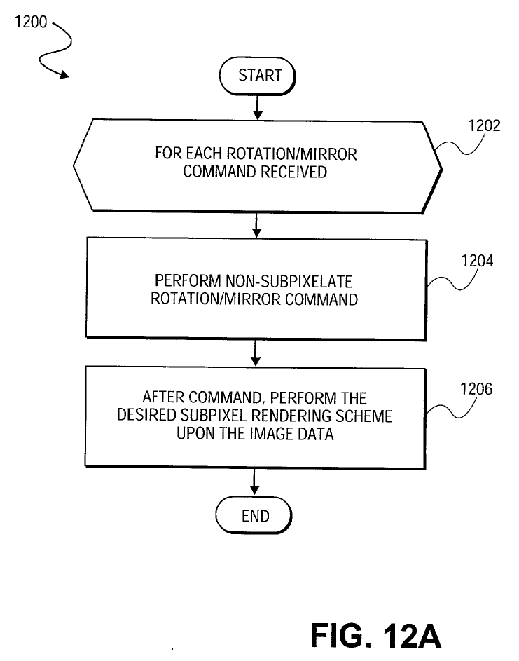

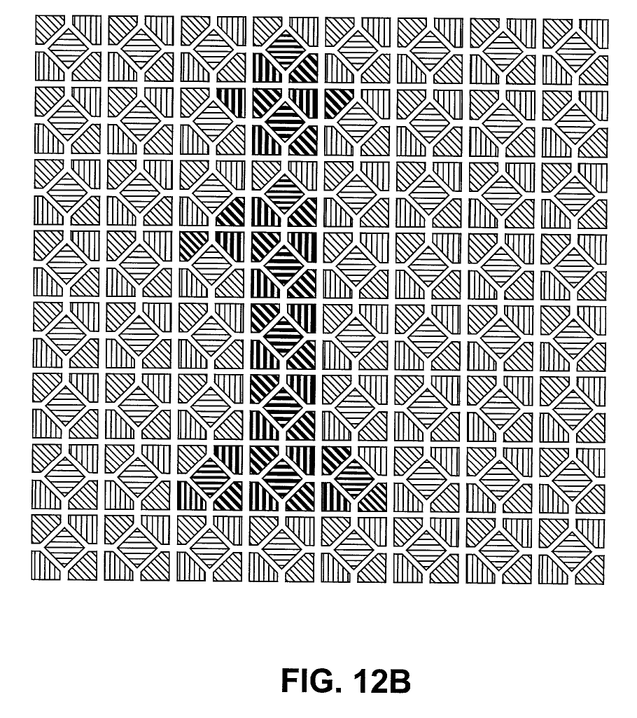

FIG. 12A describes the above embodiment 1200 as practiced in accordance with the present invention. Method 1200 starts at step 1202, wherein the system receives and accepts rotation/mirror commands—either automatically (as with a turn of the monitor) or via user-input. At step 1204, the system performs a non-sub-pixelated rotation/mirror command upon the image data.

Another method, for the PENTILE™ displays is to sub-pixel render first, then rotate the image using a modification of the Badger, or other suitable method, in which PENTILE™ groups are treated as “pixels” for the first, or high level rotation, with the additional step of rotating the data within the PENTILE™ group, again according to the parameters of the Badger, or other suitable method.

For monochrome text and images, the above embodiment should suffice. However, for non-monochromatic, that is to say, multicolor images, the above embodiment may not be sufficient, as rotating the data may introduce red/green color inversion. Of course, shifting may occur for either monochrome or multicolored images alike. Multicolor images may benefit from an additional step of shifting the red and green data by one red/green sub-pixel in the red/green checkerboard, in any orthogonal direction convenient. Such shifting restores the correct red/green color. Additionally, by moving the data in the direction of the blue stripes in one style of PENTILE™ architecture (known as “PENTILE™ 1”—as depicted in FIG. 10) architecture simplifies the calculation of the blue values. The same simplification holds, as does treating the two blue sub-pixels as one reconstruction point, similar to the single blue sub-pixel of another style of the PENTILE™ architecture (known as PENTILE™ 2—as depicted in FIG. 12B), per PENTILE™ group, during sub-pixel rendering.

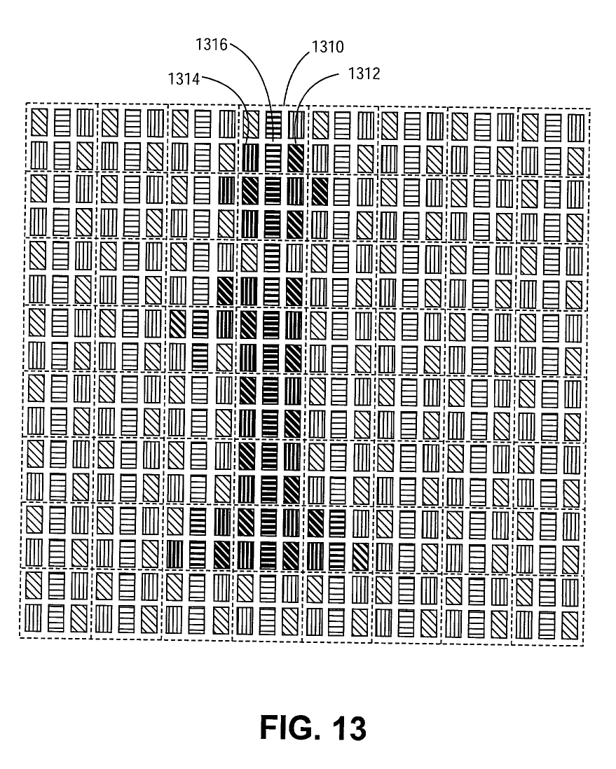

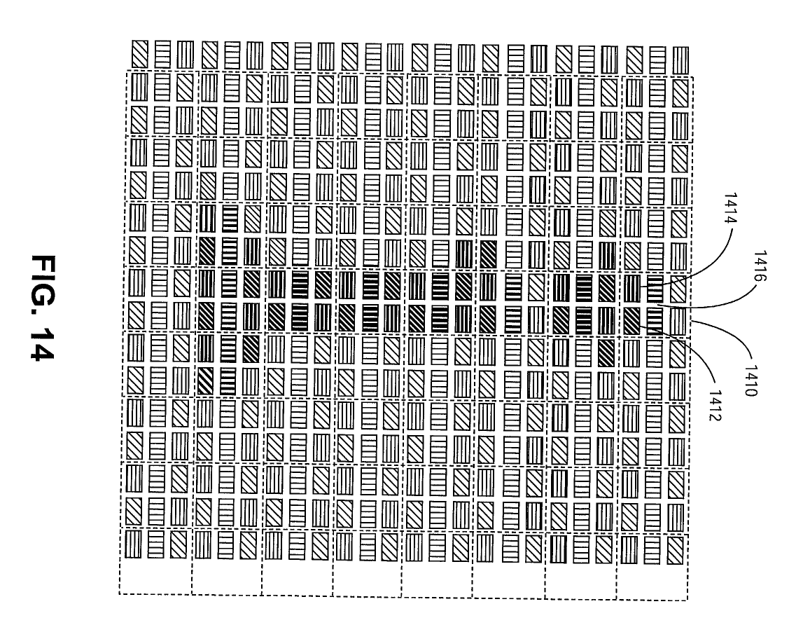

Exploring the above method closer, in FIG. 13, the PENTILE™ group 1310 is rotated and shifted to become the PENTILE™ group 1410 in FIG. 14. It should be noted that in FIG. 13, the green sub-pixel 1314 that is turned off, is remapped to the green sub-pixel 1414 in FIG. 14, while the red sub-pixel 1312 in FIG. 13 is remapped to the red sub-pixel 1412 in FIG. 14. It should also be noted that the blue data value applied to the two vertically and centrally oriented blue sub-pixels 1316 of FIG. 13 are remapped to the two horizontally and centrally oriented blue sub-pixels 1416 in FIG. 14.

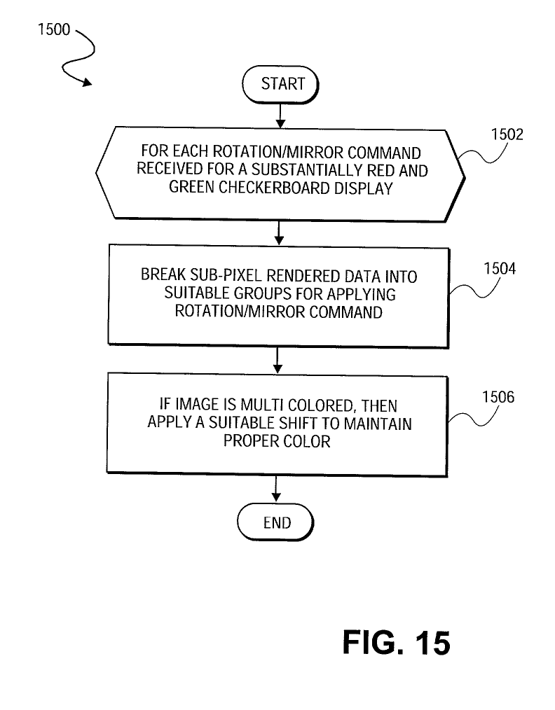

FIG. 15 is yet another embodiment made in accordance with the principles of the present invention. The method 1500 starts at step 1502 wherein rotation/mirror commands are received for a display comprising substantially a red and green check board arrangement, such as the family of PENTILE™ architectures. At step 1504, the sub-pixel rendered image data is divided into suitable groups upon which the rotation/mirror command (such as may be taught by Badger or some other suitable rotation/mirror scheme). The rotation/mirror command is then applied to these groups. At step 1506, if the image is a multicolor image, then an appropriate shift is applied to maintain the proper color.

Yet another method of rotating an image allows any rotation angle. The original high resolution image is treated as a set of implied sample areas per Elliott et al. The relative angles and position of the implied sample area and resamples are used to calculate the resample filter coefficients. Alternatively, the same concept of relative rotation resampling may be used with other sub-pixel rendering/scaling resampling algorithms known in the art, such as bilinear, bicubic, etc, or yet to be developed

This works best on high resolution images in which only a portion of the image is to be shown at a time, such as maps. This method allows scaling, panning, and rotation in a single step. If used on an image that is the same size or smaller than the size of the target display, there will be blank areas that may be filled in with “wallpaper” or other background as desired.

In the foregoing specification, the invention has been described with reference to specific exemplary embodiments thereof. It will, however, be evident that various modifications and changes may be made thereto without departing from the broader spirit and scope of the invention as set forth in the appended claims. The specification and drawings are, accordingly, to be regarded in an illustrative sense rather than a restrictive sense.

What is claimed is:

1. In a system comprising a processor, an image storage and a display, said display capable of displaying an image, and said image being renderable in a plurality of rotation degrees upon said display upon a command;
a method of rotating an image, said image further comprising at least one member of a group, said group comprising text and images capable of being sub-pixel rendered, the steps of said method comprising:
sub-pixel rendering said at least one member of a group with the inversion of a given rotation command; and
upon receipt of said rotation command, rotating said image.

2. The method as recited in claim 1 wherein said sub-pixel rendering further comprises RGB stripe sub-pixel rendering.

3. The method as recited in claim 1 wherein said sub-pixel rendering further comprises creating a data set for at least one character for a given font style.

4. The method as recited in claim 1 wherein said sub-pixel rendering further comprises creating a data set for at least one character for at least one rotation command.

5. The method as recited in claim 1 wherein said data set is pre-processed and stored within said system.

6. The method as recited in claim 1 wherein said data set is computed in real time upon receipt of a rotation command.

7. The method as recited in claim 1 wherein said rotation command comprises a mirror command.

8. The method as recited in claim 1 wherein said panel comprises one of a group of sub-pixel architectures, said group comprising RGB stripe and Pentile.

9. The method as recited in claim 1 wherein said panel comprises substantially a checkerboard of red and green sub-pixels.

10. The method as recited in claim 1 wherein said sub-pixel rendering further comprises a Nyquist limit and an addressability limit and further wherein said Nyquist limit and said addressability limit allow for substantially equal image quality in any axis of rotation.

11. In a system comprising a processor, an image storage and a display, said display capable of displaying an image and said image being renderable in a plurality of rotation degrees upon said display upon a command;
a method of rotating an image, said image further comprising at least one member of a group, said group comprising text and images capable of being sub-pixel rendered, the steps of said method comprising:
sub-pixel rendering said at least one member of a group;
grouping said sub-pixels into a plurality of sub-pixel groups; and
rotating said plurality of sub-pixel groups such that each said sub-pixel group is rotated as a pixel on a pixel-to-pixel basis.

12. The method as recited in claim 11 wherein said panel comprises a Pentile architecture.

13. The method as recited in claim 11 wherein said panel comprises substantially a checkerboard of red and green sub-pixels.

14. The method as recited in claim 12 wherein said method further comprises the step of:
shifting said rotated image by one of a group, said group comprising a red sub-pixel and a green sub-pixel.

15. The method as recited in claim 13 wherein said method further comprises the step of:
shifting said rotated image by one of a group, said group comprising a red sub-pixel and a green sub-pixel.

16. In a system comprising a processor, an image storage and a display, said display capable of displaying an image and said image being renderable in a plurality of rotation degrees upon said display upon a command;
a method of rotating an image, said image further comprising at least one member of a group, said group comprising text and images capable of being sub-pixel rendered, the steps of said method comprising:
upon receipt of said rotation command, rotating said image in accordance with said rotation command; and
sub-pixel rendering said at least one member of a group.

17. The method as recited in claim 16 wherein said rotation command comprises one of a group, said group comprising rotation command and mirror command.

18. The method as recited in claim 16 wherein said panel comprises a Pentile architecture.

19. The method as recited in claim 16 wherein said panel comprises substantially a checkerboard of red and green sub-pixels.

20. The method as recited in claim 18 wherein said method further comprises the step of:
shifting said rotated image by one of a group, said group comprising a red sub-pixel and a green sub-pixel.

21. The method as recited in claim 19 wherein said method further comprises the step of:
shifting said rotated image by one of a group, said group comprising a red sub-pixel and a green sub-pixel.

22. A system comprising a processor, an image storage and a display, said display capable of displaying an image, and said image being renderable in a plurality of rotation degrees upon said display upon a command and said image further comprising at least one member of a group, said group comprising text and images capable of being sub-pixel rendered; said system further comprising:
a means for sub-pixel rendering said at least one member of a group with the inversion of a given rotation command; and
a means for rotating said image upon receipt of said rotation command.

23. A system comprising a processor, an image storage and a display, said display capable of displaying an image, and said image being renderable in a plurality of rotation degrees upon said display upon a command and said image further comprising at least one member of a group, said group comprising text and images capable of being sub-pixel rendered; said system further comprising:
a means for sub-pixel rendering said at least one member of a group;
a means for grouping said sub-pixels into a plurality of sub-pixel groups;
a means for rotating said plurality of sub-pixel groups such that each said sub-pixel group is rotated as a pixel on a pixel-to-pixel basis.

24. A system comprising a processor, an image storage and a display, said display capable of displaying an image, and said image being renderable in a plurality of rotation degrees upon said display upon a command and said image further comprising at least one member of a group, said group comprising text and images capable of being sub-pixel rendered; said system further comprising:
a means for rotating said image upon receipt of said rotation command; and
a means for sub-pixel rendering said at least one member of a group.

25. A computer readable medium, said medium comprising steps to a method of rotating an image in a system comprising a processor, an image storage and a display, said display capable of displaying an image, and said image being renderable in a plurality of rotation degrees upon said display upon a command, said image further comprising at least one member of a group, said group comprising text and images capable of being sub-pixel rendered, the steps of said method comprising:
sub-pixel rendering said at least one member of a group with the inversion of a given rotation command; and
upon receipt of said rotation command, rotating said image.

26. A computer readable medium, said medium comprising steps to a method of rotating an image in a system comprising a processor, an image storage and a display, said display capable of displaying an image, and said image being renderable in a plurality of rotation degrees upon said display upon a command, said image further comprising at least one member of a group, said group comprising text and images capable of being sub-pixel rendered, the steps of said method comprising:
sub-pixel rendering said at least one member of a group;
grouping said sub-pixels into a plurality of sub-pixel groups; and
rotating said plurality of sub-pixel groups such that each said sub-pixel group is rotated as a pixel on a pixel-to-pixel basis.

27. A computer readable medium, said medium comprising steps to a method of rotating an image in a system comprising a processor, an image storage and a display, said display capable of displaying an image, and said image being renderable in a plurality of rotation degrees upon said display upon a command, said image further comprising at least one member of a group, said group comprising text and images capable of being sub-pixel rendered, the steps of said method comprising:
upon receipt of said rotation command, rotating said image in accordance with said rotation command; and
sub-pixel rendering said at least one member of a group.
